(19) United States
(12) Patent Application Publication
(10) Pub. No.: US 2023/0253155 A1
(43) Pub. Date: Aug. 10, 2023

(54) CAPACITOR

(71) Applicant: Murata Manufacturing Co., Ltd., Nagaokakyo-shi (JP)

(72) Inventors: Yasuhiro SHIMIZU, Nagaokakyo-shi (JP); Masaki NAGATA, Nagaokakyo-shi (JP)

(21) Appl. No.: 18/193,714

(22) Filed: Mar. 31, 2023

Related U.S. Application Data
(63) Continuation of application No. PCT/JP2021/041733, filed on Nov. 12, 2021.

(30) Foreign Application Priority Data
Nov. 19, 2020 (JP) 2020-192342

(51) Int. Cl. H01G 4/16; H01G 4/224

(52) U.S. Cl. CPC H01G 4/16; H01G 4/224

(57) ABSTRACT

A capacitor that includes: a substrate; a fixing layer with a first main surface and a second main surface that face each other, the first main surface being in contact with a surface of the substrate; a plurality of fibrous core materials each having a first embedded in the fixing layer and a second end exposed from the fixing layer; a dielectric layer covering the second end of each of the plurality of fibrous core materials; and a conductor layer covering the dielectric layer, wherein a length of a part of each of the plurality of fibrous core materials embedded in the fixing layer is larger than a distance between a contact between the plurality of fibrous core materials and the second main surface of the fixing layer and the first main surface of the fixing layer.

### CROSS REFERENCE TO RELATED APPLICATIONS

The present application is a continuation of International application No. PCT/JP2021/041733, filed Nov. 12, 2021, which claims priority to Japanese Patent Application No. 2020-192342, filed Nov. 19, 2020, the entire contents of each of which are incorporated herein by reference.

### FIELD OF THE INVENTION

The present invention relates to a capacitor, and more particularly to a capacitor, which may have a conductor-dielectric-conductor structure.

### BACKGROUND OF THE INVENTION

Conventionally, vertically aligned carbon nanotubes (Vertically aligned carbon nanotubes, hereinafter referred to also as “VACNTs”) are known to be usable for electrodes of electric double layer capacitors, field emission cold cathodes, and the like (for example, see Patent Documents 1 to 2).

More specifically, Patent Documents 1 to 2 disclose allowing VACNTs to grow on a synthetic substrate with a catalyst attached thereto, then pressing the VACNTs on the synthetic substrate against a conductive adhesive layer of a separately prepared substrate with the conductive adhesive layer (or conductive binder) to bond the VACNTs to adhesive layer, and peeling the synthetic substrate off to transfer the VACNTs, as a result, allowing the manufacture of a structure with the VACNTs fixed to the substrate with the adhesive layer interposed therebetween.
Patent Document 1: Japanese Patent Application Laid-Open No. 2004-127737
Patent Document 2: Japanese Patent Application Laid-Open No. 2004-281388

### SUMMARY OF THE INVENTION

A VACNT is a conductor that has a large specific surface area. Thus, it is believed that large capacitance can be obtained if such a VACNT can be used, in a capacitor that has a conductor-dielectric-conductor structure, as one of the conductors (in other words, a base for a dielectric) or as a base for one of the conductors. The studies of the inventors, however, have found that the manufacture of a capacitor that has VACNTs fixed to a substrate with an adhesive layer (fixing layer) interposed therebetween by the conventionally known method as described above has a problem that the phenomenon of peeling the VACNTs off from the adhesive layer (fixing layer) may be caused due to thermal stress or mechanical stress that may be applied in the process of manufacturing the capacitor and/or during the use thereof by a user (described later in more detail with reference to FIG. 7). When the VACNTs are peeled off from the adhesive layer, desired capacitance fails to be obtained in the capacitor, which leads to product defects and/or failures, and fails to obtain high reliability.

Such a phenomenon as mentioned above may be caused, not only in capacitors that have VACNTs, but also in common in capacitors that have a plurality of fibrous core materials fixed to a substrate with a fixing layer interposed therebetween.

An object of the present invention is to achieve a highly reliable capacitor that has a plurality of fibrous core materials fixed to a substrate with a fixing layer interposed therebetween.

According to one scope of the present invention, provided is a capacitor including: a substrate; a fixing layer with a first main surface and a second main surface that face each other, the fixing layer disposed to have the first main surface in contact with a surface of the substrate; a plurality of fibrous core materials each having a first end and a second end, the first end of each of the plurality of fibrous core materials being embedded in the fixing layer, and the second end of each of the plurality of fibrous core materials being exposed from the fixing layer; a dielectric layer covering the second end of each of the plurality of fibrous core materials that are exposed from the fixing layer; and a conductor layer covering the dielectric layer, wherein a length of a part of each of the plurality of fibrous core materials embedded in the fixing layer is larger than a distance between a contact between the plurality of fibrous core materials and the second main surface of the fixing layer and the first main surface of the fixing layer.

In one aspect of the present invention, for each of the plurality of fibrous core materials, the boundary between the part thereof covered with the dielectric layer and the part exposed from the dielectric layer is located outside the fixing layer.

In one aspect of the present invention, the plurality of fibrous core materials may be each a nanotube or a nanorod, preferably a carbon nanotube.

In one aspect of the present invention, at least the surface of the substrate may be made of a metal.

In one aspect of the present invention, the conductor layer may extend to fill the surface irregularity of the dielectric layer on the side thereof opposite to the plurality of fibrous core materials.

In one aspect of the present invention, the plurality of fibrous core materials and the fixing layer may have conductivity.

In another aspect of the present invention, the capacitor further include another conductor layer between the plurality of fibrous core materials and the dielectric layer.

In one aspect of the present invention, the surface of the substrate may have irregularities.

In the capacitor according to the present invention, the length of the part embedded in the fixing layer among the plurality of fibrous core material is larger than the distance between the contact between the plurality of fibrous core materials at the second surface of the fixing layer and the first surface of the fixing layer, thereby the phenomenon of peeling the plurality of fibrous core materials from the fixing layer can be effectively prevented. More specifically, the present invention achieves a highly reliable capacitor that has a plurality of fibrous core materials fixed to a substrate with a fixing layer interposed therebetween.

### BRIEF EXPLANATION OF THE DRAWINGS

FIG. 1 shows a schematic sectional view of one exemplary capacitor according to one embodiment of the present invention.

FIG. 2 shows a schematic sectional view of another exemplary capacitor according to one embodiment of the present invention.

FIG. 3 shows a schematic sectional view of a capacitor according to a modification example according to one embodiment of the present invention.

FIG. 4 shows a schematic sectional view of one exemplary capacitor according to another embodiment of the present invention.

FIG. 5 shows a schematic sectional view of a capacitor according to a modification example according to another embodiment of the present invention.

FIG. 6 shows a schematic sectional view of a capacitor according to yet another embodiment of the present invention.

FIG. 7 shows a schematic cross-sectional view of one exemplary capacitor described in the present specification for the purpose of comparison to the present invention.

### DETAILED DESCRIPTION OF THE INVENTION

Capacitors according to three embodiments of the present invention will be described in detail below with reference to the drawings, but the present invention is not limited to these embodiments.

### Embodiment 1

The present embodiment relates to an aspect in which a plurality of fibrous core materials are directly covered with a dielectric layer.

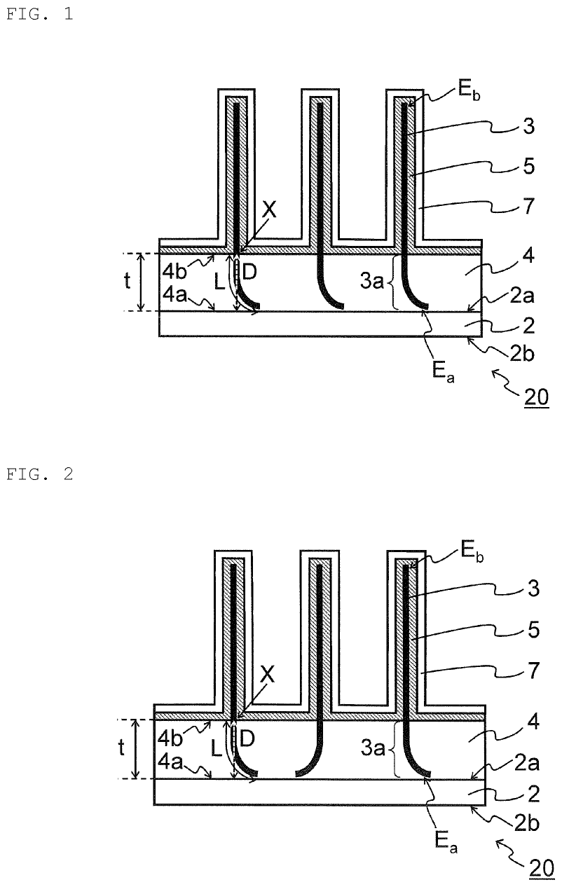

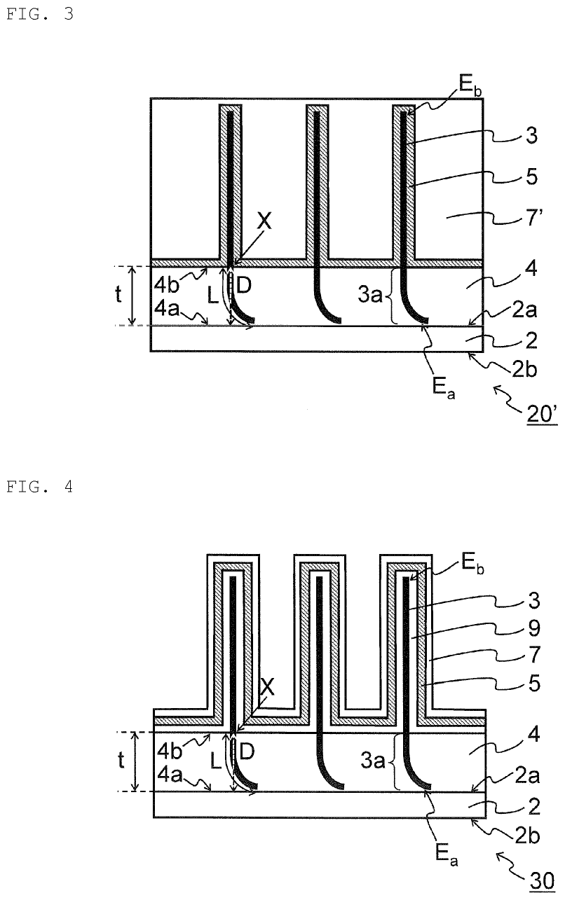

Referring to FIGS. 1 to 2, a capacitor 20 according to the present embodiment includes: a substrate 2; a plurality of fibrous core materials 3; and a fixing layer 4 with two main surfaces 4a and 4b facing each other, disposed to have one of the main surfaces 4a in contact with a surface 2a of the substrate 2, the fixing layer 4 embedding and fixing one end Eₐ for each of the plurality of fibrous core materials 3. According to the present embodiment, the fixing layer 4 may embed one end Eₐ of each of the plurality of fibrous core materials 3 so as to fix the plurality of fibrous core materials 3 vertically oriented with respect to the substrate 2, but this is not essential for the present invention.

In the capacitor 20 according to the present embodiment, the plurality of fibrous core materials 3 are each, with at least the one end E_{b} exposed (in other words, excluding the at least the one end Eₐ), covered with a dielectric layer 5 directly according to the present embodiment. Further, the dielectric layer 5 is covered with a conductor layer (first conductor layer) 7. Thus, one end Eₐ of each of the plurality of fibrous core materials 3 is exposed from the dielectric layer 5 and the conductor layer 7, and embedded in the fixing layer 4.

In the present embodiment, the plurality of fibrous core materials 3 have conductivity (in other words, conductors), and can be kept at the same potential or voltage with the fixing layer 4 and/or the substrate 2 interposed therebetween. Accordingly, a conductor-dielectric-conductor structure is formed by the plurality of fibrous core materials 3, the dielectric layer 5, and the conductor layer 7. Such a conductor-dielectric-conductor structure can be understood as corresponding to a so-called MIM structure (metal-insulator-metal structure). The capacitor 20 that has such a structure can obtain large capacitance from the large specific surface area of the plurality of fibrous core materials 3.

In addition, the capacitor 20 according to the present embodiment is characterized in that the length L of a part (fixing layer embedded part) 3a embedded in the fixing layer 4 among the plurality of fibrous core materials 3 is larger than the distance D between the contact X between the plurality of fibrous core materials at the other main surface 4b of the fixing layer (in other words, the sections of the fibrous core materials on the surface including the other main surface 4b) and the one main surface 4a of the fixing layer 4. The contact X is located on the other main surface 4b of the fixing layer 4, and thus, when the thickness t of the fixing layer is uniform, the distance D between the contact X and the main surface 4a may be considered equal to the thickness t of the fixing layer. With such a feature, (if the distance D, and thus the thickness t of the fixing layer 4 are not increased), the area of contact between the plurality of fibrous core materials 3 and the fixing layer 4 can be sufficiently increased, furthermore, the anchor effect can be obtained, and the adhesive strength therebetween can be increased. Thus, if thermal stress or mechanical stress is applied in the process of manufacturing the capacitor 20 and/or during the use thereof by a user, the phenomenon of peeling the plurality of fibrous core materials 3 from the fixing layer 4 can be effectively prevented, and defects and/or failures of the product (capacitor 20) can be effectively reduced. In other words, the capacitor 20 with high reliability can be achieved.

In the present invention, the fact that the length L of the part embedded in the fixing layer (also referred to as a “fixing layer embedded part” in the present specification) among the plurality of fibrous core materials is larger than the distance D between the contact X between the plurality of fibrous core materials and the other main surface of the fixing layer and the one main surface of the fixing layer means that the following Formula (1) is satisfied.

L_{AVE}−2σ>D (1)

In the formula, each symbol has the following meanings:

L_{AVE}: the average value of the lengths of fixing layer embedded parts of 100 fibrous core materials

σ: the standard deviation of the length of fixing layer embedded parts of 100 fibrous core materials

D: the average value of the distances between: contacts between 100 fibrous core materials at the other main surface of the fixing layer and the one main surface of the fixing layer (when the thickness t of the fixing layer is uniform, the thickness t may be applied instead of the distance D)

The lengths of the fixing layer embedded parts of the 100 fibrous core materials, and the distances between the contacts between the 100 fibrous core materials at the other main surface of the fixing layer and the one main surface of the fixing layer (hereinafter, these are collectively referred to also as “the lengths of the fixing layer embedded parts of the 100 fibrous core members, and the like”) are measured as follows. First, at least 100 fibrous core materials are exposed by cutting out a thickness-direction section of the fixing layer. The cross section thus obtained is imaged with a scanning electron microscope (SEM), and from this SEM photograph, the lengths of the fixing layer embedded parts of 100 fibrous core materials are measured among the materials exposed as described above. From this SEM photograph, the contacts with the other main surface of the fixing layer (which may be sections on the other main surface for each of the fibrous core materials) are determined for the 100 fibrous core materials mentioned above, and the distances between the contacts and the one main surface of the fixing layer are measured. When the thickness of the fixing layer is uniform (or substantially uniform), the measurement of the distances between the contacts between the 100 fibrous core materials at the other main surface of the fixing layer and the one main surface of the fixing layer may be omitted, and the thickness of the fixing layer may be then applied. The thickness of the fixing layer is measured from the thickness-direction section cut out as mentioned above with the use of a scanning electron microscope (SEM). When the thickness of the fixing layer is not uniform, the maximum thickness in the section may be applied for convenience. It is to be noted that the “thickness direction” means a direction perpendicular to the surface of the substrate (so-called main surface in the case of having irregularities as described later). Cutting out the thickness-direction section of the fixing layer, and measuring the lengths of the fixing layer embedded parts of the fibrous core materials, and the like are not particularly limited as long as the lengths of the fixing layer embedded parts of the 100 fibrous core members, and the like can be finally measured, and for example, the combination of the cutting out and measuring the lengths and the like may be performed at a time, or may be sequentially performed multiple times.

Assuming that the length of the fixing layer embedded part of the fibrous core material statistically follows a normal distribution by satisfying the formula (1) mentioned above, 97.5% (=95%+5/2%) of all of the fibrous core materials is understood to satisfy L>D, from the “68-95-99.7 rule”. From the foregoing, the probability of the phenomenon of peeling the plurality of fibrous core materials from the fixing layer, in other words, the probability of the product defect and/or failure caused by the peeling (caused by failing to obtain desired capacitance due to the peeling) is believed to be successfully reduced to 2.5% or less.

It should be noted that in the present invention, the fact that the lengths L of the fixing layer embedded parts 3a of the plurality of fibrous core materials 3 are larger than the distances D between the contacts X between the plurality of fibrous core materials 3 at the other main surface 4b of the fixing layer 4 and the one main surface 4a of the fixing layer 4 means that the formula (1) mentioned above has only to be satisfied, and there is no need for all of the fibrous core materials 3 of the capacitor to satisfy L>D.

For the purpose of comparison, FIG. 7 shows a capacitor 60 where the lengths L′ of fixing layer embedded parts 63a of a plurality of fibrous core materials 63 are smaller than the distances D (when the thickness t of the fixing layer is uniform, the thickness t can be applied instead of the distances D) between the contacts X between the plurality of fibrous core materials 63 at the other main surface 64b of a fixing layer 64 and the one main surface 64a of the fixing layer 64. The capacitor 60 can be manufactured by applying a conventionally known method as described in Patent Literature 1 or 2, for example. In the capacitor 60, the phenomenon of peeling the plurality of fibrous core materials 63 from the fixing layer 64 may be caused by thermal stress or mechanical stress that may be applied in the process of manufacturing the capacitor and/or during the use thereof by a user, and as a result, the capacitor 60 fails to obtain desired capacitance, thereby leading to a product defect and/or failure, and failing to obtain high reliability. According to the findings of the present inventors, it is believed that the reason of occurrence of the phenomenon is that the plurality of fibrous core materials 63 are embedded only in the direction perpendicular to the fixing layer 64. In the capacitor 60 where the lengths L′ of the fixing layer embedded parts 63a of the plurality of fibrous core materials 63 are smaller than the distances D between the contacts X between the plurality of fibrous core materials 63 at the other main surface 64b of a fixing layer 64 and the one main surface 64a of the fixing layer 64, for preventing the plurality of fibrous core materials 63 from being peeled, it is conceivable to increase the distances D, and thus the thickness of the fixing layer 64, thereby increasing the areas of contacts between the fixing layer embedded parts 63a and the fixing layer 64, and then increasing the adhesive strength therebetween. In this case, however, the increased distances D, and thus the increased thickness of the fixing layer 64 leads to an increase in the size (more specifically, the height) of the capacitor 60, leading to another problem of sacrificing the effective specific surface area per volume of the capacitor 60. This is not preferable because of going against the reduction in size (more particularly, the reduction in height), which is a market demand.

In contrast, in the capacitor 20 (see FIGS. 1 to 2) according to the present embodiment, because of the feature mentioned above, if the distances D, and thus the thickness t of the fixing layer 4 are not increased, the areas of contacts between the plurality of fibrous core materials 3 and the fixing layer 4 can be sufficiently increased, and the adhesive strength therebetween can be increased. Accordingly, the capacitor 20 with high reliability can be achieved without sacrificing the effective specific surface area per volume. From another point of view, the capacitor 20 that has a high electrostatic capacitance density achieved and has a small size (more particularly, a small height) can be achieved.

In the capacitor 20 according to the present embodiment, the directions in which the ends Eₐ of the plurality of fibrous core materials 3 face may be aligned as exemplarily illustrated in FIG. 1, or may fail to be aligned (may be random) as exemplarily illustrated in FIG. 2. In any case, the fixing layer embedded parts 3a of the plurality of fibrous core materials 3 may have substantially the same length or different lengths (long parts and short parts may be mixed). It is to be noted that while three fibrous core materials 3 are schematically illustrated in the accompanying drawings, the present embodiment is not limited thereto.

In the present embodiment, the plurality of fibrous core materials 3 are oriented such that the longitudinal direction thereof (more particularly, the longitudinal direction of the part excluding the fixing layer embedded parts 3a of the plurality of fibrous core materials 3) thereof is perpendicular to the substrate 2. It is to be noted that the term “perpendicular” means being substantially perpendicular (for example, within the range of ±15 degrees, preferably within the range of ±10 degrees) to the surface (so-called main surface) of the substrate. It is to be noted that there is no need for all of the fibrous core materials 3 of the capacitor to be perpendicular to the surface of the substrate, and a relatively small proportion of the fibrous core materials 3 may be curved, bent, and/or inclined.

The fibrous core material 3 (each of the plurality of fibrous core materials 3) is not particularly limited as long as the longitudinal-direction dimension (length) thereof is larger (preferably significantly) than the maximum dimension of a section perpendicular to the longitudinal direction, or schematically, the material is an elongated thread-like material.

The length and sectional maximum dimension (the diameter in the case of having a substantially circular section, the same applies hereinafter) of the fibrous core material 3 are not particularly limited.

The length of the fibrous core material 3 is preferably larger, because the capacitance density per area can be increased. The length of the fibrous core material 3 may be, for example, several μm or more, 20 μm or more, 50 μm or more, 100 μm or more, 500 μm or more, 750 μm or more, 1000 μm or more, or 2000 μm or more. The upper limit of the length of the fibrous core material 3 can be appropriately selected, but the length of the fibrous core material may be, for example, 10 mm or less, 5 mm or less, or 3 mm or less.

The sectional maximum dimension of the fibrous core material 3 may be, for example, 0.1 nm or more, 1 nm or more, or 10 nm or more. The sectional maximum dimension of the fibrous core material 3 may be 1000 nm or less, 800 nm or less, or 600 nm or less.

The distance between the adjacent fibrous core materials 3 is preferably smaller, because the capacitance density per area can be increased. The distance between the adjacent fibrous core materials 3 may be, for example, 10 nm to 1 μm.

The fibrous core material 3 is preferably a nanofiber (in sectional maximum dimension on a nanoscale (1 nm to less than 1000 nm)). The nanofiber may be, for example, a nanotube (hollow, preferably cylindrical) or a nanorod (solid, preferably cylindrical). Nanorods with electrical conductivity (including semiconductivity) are referred to also as nanowires.

The nanofiber that can be used in the present invention is not particularly limited, and examples thereof include carbon nanofibers and cellulose nanofibers. The nanotube that can be used in the present invention is not particularly limited, and examples thereof include metal-based nanotubes, organic nanotubes, and inorganic nanotubes. Typically, the nanotube may be a carbon nanotube or a titania carbon nanotube. The nanorod (nanowire) that can be used in the present invention is not particularly limited, and examples thereof include silicon nanowires and silver nanowires.

The fibrous core material 3 that can be used in the present embodiment has conductivity among those described above. The fibrous core material 3 with conductivity can function as one conductor in the conductor-dielectric-conductor structure.

Preferably, the fibrous core material 3 is a carbon nanotube. Carbon nanotubes have electrical and thermal conductivity. Carbon nanotubes are high in strength and flexibility, and are likely to kept vertically aligned.

The chirality of the carbon nanotube is not particularly limited, and may have either a semiconductor type or a metal type, or a mixture thereof may be used. From the viewpoint of reducing the resistance value, the ratio of the metal type is preferably high.

The number of layers of the carbon nanotube is not particularly limited, and may be either a SWCNT (single-walled carbon nanotube) that has one layer or a MWCNT (multi-walled carbon nanotube) that has two or more layers.

The method for producing carbon nanotubes is not particularly limited, and any suitable method may be used.

Preferably, the plurality of fibrous core materials 3 are vertically aligned carbon nanotubes (VACNTs). The VACNTs has the advantage of having a large specific surface area, thus allowing the grow and then production of the VACNTs vertically aligned on a synthetic substrate.

The method for producing the VACNT is not particularly limited, and chemical vapor deposition (CVD), plasma enhanced CVD, or the like can be used on heating, if necessary. In this case, iron, nickel, platinum, cobalt, an alloy containing these, or the like is used as a catalyst. The material of the substrate to which the catalyst is attached is not particularly limited, and for example, silicon oxide, silicon, gallium arsenide, aluminum, SUS, and the like can be used. Sputtering, physical vapor deposition (PVD), and the like can be used for the method for attaching the catalyst to the synthetic substrate, and such a technique may be optionally combined with a technique such as lithography or etching. The gas used is not particularly limited, and for example, at least one selected from the group consisting of carbon monoxide, methane, ethylene, and acetylene, or a mixture of at least one thereof and hydrogen and/or ammonia can be used. On the synthesis substrate with the catalyst attached thereto, VACNTs grow with the catalyst as a nucleus. The end of the VACNT on the side of the synthetic substrate with the catalyst attached is a fixed end that is fixed to the synthetic substrate (typically with the catalyst interposed therebetween), and the opposite end of the VACNT is a free end that is a growth point. The length and diameter of the VACNT may vary depending on changes in parameters such as a gas concentration, a gas flow rate, and a temperature. More specifically, the length and diameter of the VACNT can be adjusted by appropriately selecting these parameters. If desired, moisture may be present in the ambient atmosphere for the grow of the VACNTs.

The present embodiment is, however, not limited thereto, and the plurality of fibrous core materials 3 may be produced, for example, with the materials oriented in a certain direction in a dispersion liquid.

The substrate 2 has the surface 2a and a back surface 2b facing each other, and may have the form of, for example, a plate (substrate), a foil, a film, or a block shape. The surface 2a and/or back surface 2b of the substrate 2 may be smooth, or may have irregularities. When the surface 2a of the substrate 2 has irregularities, the adhesive strength between the substrate 2a and the fixing layer 4 can be increased. The irregularities can be formed by, for example, a surface treatment (surface roughening treatment), and can be preferably fine irregularities. The sizes of the irregularities are not particularly limited, and may be, for example, ±5 μm.

The thickness of the substrate 2 is not particularly limited, and can vary depending on the application of the capacitor 20.

The material constituting the substrate 2 is not particularly limited, and may be, for example, a conductive material such as metal, or an insulating (or relatively low conductive) material such as a ceramic or a resin. The substrate 2 may be composed of one kind of material, or a mixture of two or more kinds of materials, or may be a composite composed of two or more kinds of materials. For example, the substrate 2 may be a foil or a plate made of a metal (for example, aluminum or copper). In addition, for example, the substrate 2 may have a metal layer formed on a surface side and/or a back-surface side of a support material made of an insulating material. The metal layer can be formed by use of, for example, atomic layer deposition (ALD), sputtering, coating, plating, or the like. The metal layer may be a layer extending over the entire surface or may be formed by patterning.

The fixing layer 4 is disposed on the surface 2a of the substrate 2 (so as to provide the one main surface 4a in contact with the surface 2a). The fixing layer 4 has one end Eₐ buried therein for each of the plurality of fibrous core materials 3 (in the present embodiment, such that the plurality of fibrous core materials 3 are fixed while being vertically aligned with respect to the substrate 2). In the fixing layer 4, the fixing layer embedded parts 3a of the plurality of fibrous core materials 3 may have any shape, and may be curved and/or bent, for example. The fixing layer embedded parts 3a of the plurality of fibrous core materials 3 may be optionally kept in contact with the substrate 2. The fixing layer embedded parts 3a of the plurality of fibrous core materials 3 may be optionally kept in contact with and/or entangled with each other, but when the fixing layer embedded parts 3a are kept in contact with and/or entangled with each other, the peeling phenomenon can be more effectively prevented.

The thickness t of the fixing layer 4 is preferably 1 μm to 100 μm, more preferably 5 μm to 50 μm, and the distance D may fall within the same range.

The material constituting the fixing layer 4 is not particularly limited, but may be any suitable curable material (so-called adhesive). The fixing layer 4 can also be understood as an adhesive layer that bonds the plurality of fibrous core materials 3 (in the present embodiment, vertically aligned with respect to the substrate 2).

The curable material that can be used in the present invention may be a material that is made curable by heat, light, radiation, moisture, or the like, and is preferably a thermosetting material. The curable material may be a known adhesive or adhesive paste, and may optionally include a conductive filler.

In the present embodiment, the fixing layer 4 preferably has conductivity. The plurality of fibrous core materials 3 and the fixing layer 4 have conductivity, thereby allowing the plurality of fibrous core materials 3 to be reliably kept at the same potential or voltage.

When the fixing layer 4 has conductivity, a conductive curable material is selected as a material constituting the fixing layer 4.

Examples of the conductive curable material include a conductive filler dispersed in any suitable curable resin/polymer, and a conductive and curable resin/polymer. Examples of the former include a material that has a metal filler such as gold, silver, nickel, copper, tin, or palladium, or a carbon filler dispersed in a resin such as an epoxy resin, a polyimide resin, a silicone resin, or a polyurethane resin. Examples of the latter include polypyrroles, polypyrrole derivatives, polyanilines, polyaniline derivatives, polythiophenes, and polythiophene derivatives.

The curable material may have the form of a paste, a sheet, a gel, or a liquid. For facilitating the introduction of the curable material into the gaps between the plurality of fibrous core materials 3, preferred is a liquid or gel-like curable material, or a thermosetting material that can be liquid or gel-like with the viscosity decreased once during heating.

The method for embedding one end Eₐ for each of the plurality of fibrous core materials 3 in the fixing layer 4 so as to fix the plurality of fibrous core materials 3 (in the present embodiment, vertically aligned with respect to the substrate 2) is not particularly limited, and any suitable method can be applied.

More particularly, in the case of using VACNTs (flexible) as the plurality of fibrous core materials 3, for example, any one of the following embedding methods 1 to 3 may be applied.

Embedding Method 1

(1-a) First, as described above, VACNTs are allowed to grow on a synthetic substrate.

(1-b) Separately, a curable material is applied onto the surface 2a of the substrate 2 to reach a suitable thickness.

(1-c) The VACNTs allowed to grow on the synthetic substrate in the foregoing (1-a) and the substrate 2 with the curable material applied to the surface 2a in the foregoing (1-b) are disposed such that the free ends of the VACNTs face the curable material, and such that the longitudinal directions of the VACNTs are perpendicular to the substrate 2.

(1-d) Then, the synthetic substrate with VACNTs is pressed toward the substrate 2. In this case, the synthetic substrate is pressed such that the distance between the synthetic substrate surface on which the fixed ends of the VACNTs are located and the surface 2a of the substrate 2 is smaller than the original lengths of the VACNTs allowed to grow substantially straight, thereby pressing and inserting the VACNTs into the curable material, and bringing the free ends (ends Eₐ) of the VACNTs into contact with the surface 2a of the substrate 2 and then bending the VACNTs in the curable material. As a result, the directions in which the respective ends Eₐ of the plurality of fibrous core materials 3 (VACNTs) are oriented can be random.

(1-e) In the foregoing condition (1-d), the curable material is subjected to curing to form the fixing layer 4.

(1-f) Thereafter, the synthetic substrate is peeled off.

Embedding Method 2

(2-a) First, as described above, VACNTs are allowed to grow on a synthetic substrate.

(2-b) Separately, a curable material is applied onto the surface 2a of the substrate 2 to reach a suitable thickness.

(2-c) The VACNTs allowed to grow on the synthetic substrate in the foregoing (2-a) and the substrate 2 with the curable material applied on the surface 2a in the foregoing (b) are disposed such that the longitudinal directions of the VACNTs are perpendicular to the substrate 2, while the free ends of the VACNTs are located on the lateral side of the substrate 2 with the curable material applied. In this case, the distance between the synthetic substrate surface on which the fixed ends of the VACNTs are located and the surface 2a of the substrate 2 is made smaller than the original lengths of the VACNTs to allowed grow substantially straight.

(2-d) Then, the synthetic substrate with VACNTs is slid parallel to the substrate 2. In this case, the synthetic substrate is slid with the distance between the synthetic substrate surface on which the fixed ends of the VACNTs are located and the surface 2a of the substrate 2 being smaller than the original lengths of the VACNTs allowed to grow substantially straight, thus sliding and inserting the VACNTs into the curable material, and bringing side surfaces near the free ends (ends Eₐ) of the VACNTs into contact with the surface 2a of the substrate 2 and then bending the VACNTs in the curable material. As a result, the directions in which the respective ends Eₐ of the plurality of fibrous core materials 3 (VACNTs) are oriented can be aligned in the sliding direction.

(2-e) In the foregoing condition (2-d), the curable material is subjected to curing to form the fixing layer 4.

(2-f) Thereafter, the synthetic substrate is peeled off.

Embedding Method 3

(3-a) First, as described above, VACNTs are allowed to grow on a synthetic substrate.

(3-b) The VACNTs allowed to grow on the synthetic substrate in the foregoing (3-a) and the substrate 2 are disposed such that the longitudinal directions of the VACNTs are perpendicular to the substrate 2, while the free ends of the VACNTs are located on the lateral side of the substrate 2. In this case, the distance between the synthetic substrate surface on which the fixed ends of the VACNTs are located and the surface 2a of the substrate 2 is made smaller than the original lengths of the VACNTs to allowed grow substantially straight.

(3-c) Then, the synthetic substrate with VACNTs is slid parallel to the substrate 2. In this case, the synthetic substrate is slid with the distance between the synthetic substrate surface on which the fixed ends of the VACNTs are located and the surface 2a of the substrate 2 being smaller than the original lengths of the VACNTs allowed to grow substantially straight, thus bringing side surfaces near the free ends (ends Eₐ) of the VACNTs into contact with the surface 2a of the substrate 2 and then bending the VACNTs. As a result, the directions in which the respective ends Eₐ of the plurality of fibrous core materials 3 (VACNTs) are oriented can be aligned in the sliding direction.

(3-d) In the foregoing condition (3-c), the curable material is poured onto the surface 2a of the substrate 2 to reach a suitable thickness. As a result, the ends Eₐ of the VACNTs are immersed in the curable material.

(3-e) In the foregoing condition (3-d), the curable material is subjected to curing to form the fixing layer 4.

(3-f) Thereafter, the synthetic substrate is peeled off.

In accordance with any of the embedding methods 1 to 3 described above, the free ends of the VACNTs are embedded as the ends Eₐ in the fixing layer 4, and the fixed ends of the VACNTs are disposed outside the fixing layer 4. The fixed ends of the VACNTs are originally located in the same plane, and will be thus located at a uniform height from the surface 2a of the substrate 2. In other words, variations in height for the plurality of fibrous core materials in the plane of the substrate 2 can be reduced (preferably, made uniform).

In the present embodiment, the material constituting each of the plurality of fibrous core materials 3, substrate 2, and fixing layer 4 can be appropriately selected depending on the methods for forming the fixing layer 4, the dielectric layer 5, and the conductor layer 7 (including conditions such as a temperature), the application of the capacitor 20, and the like.

In the case of using a thermally conductive substance such as a carbon nanotube as the plurality of fibrous core materials 3 and forming the fixing layer 4 on heating with the use of a thermosetting material, at least the surface 2a of the substrate 2 is made of a metal. When the plurality of fibrous core materials 3 have thermal conductivity, heat dissipation is enhanced, but at least the surface 2a of the substrate 2 is made of a metal, thereby allowing the thermosetting material disposed on the surface 2a of the substrate 2 to be uniformly heated, and then allowing stable thermal curing to be achieved. As a result, variations in the adhesive strength of the plurality of fibrous core materials 3 in the plane of the fixing layer 4 thus formed can be reduced (preferably made uniform). For the substrate 2 with at least the surface 2a made of a metal, the whole substrate 2 may be made of a metal (for example, a metal foil or a metal plate), or the substrate 2 may have a metal layer on the surface 2a.

Referring again to FIGS. 1 to 2, the plurality of fibrous core materials 3 are each covered with the dielectric layer 5, for the part excluding the fixing layer embedded part 3a, and the dielectric layer 5 is covered with the conductor layer 7.

From another point of view, for each of the plurality of fibrous core materials 3, the boundary between the part covered with the dielectric layer 5 and the part exposed from the dielectric layer 5 is not present inside the fixing layer 4, but is thus located outside (or may be located on the surface) the fixing layer 4. In the present embodiment, for each of the plurality of fibrous core materials 3, the boundary between the part covered with the dielectric layer 5 and the part exposed from the dielectric layer 5 is located in the same plane as the outer surface of the fixing layer 4.

The thickness of the dielectric layer 5 is preferably 5 nm or more, more preferably 10 nm or more. The dielectric layer has a thickness of 5 nm or more, thereby allowing the dielectric property to be enhanced, and allowing the leakage current to be reduced. In addition, the thickness of the dielectric layer 5 is preferably 100 nm or less, more preferably 50 nm or less. The dielectric layer 5 has a thickness of 100 nm or less, thereby allowing a higher electrostatic capacitance to be obtained.

The dielectric material (or insulating material) constituting the dielectric layer 5 is not particularly limited, and examples thereof include a silicon dioxide, an aluminum oxide, a silicon nitride, a tantalum oxide, a hafnium oxide, a barium titanate, and a lead zirconate titanate. These materials may be used alone, or two or more thereof may be used (for example, as a laminate).

The film formation method for the dielectric layer 5 is not particularly limited, and ALD, sputtering, CVD, PVD, a sol-gel method, a film formation method with a supercritical fluid used, or the like can be used.

The thickness of the conductor layer 7 may be, for example, 3 nm or more, preferably 10 nm or more. The thickness of the conductor layer 7 is 3 nm or more, thereby allowing the resistance value of the conductor layer 7 itself to be reduced. In addition, the thickness of the conductor layer 7 may be, for example, 500 nm or less, particularly 100 nm or less. In the present embodiment, the conductor layer 7 may be, as illustrated, provided with gaps (or a first trench structure) corresponding to the spaces between the plurality of fibrous core materials 3. The thickness of the conductor layer 7 may be, however, larger as in a modification example described later.

The conductive material constituting the conductor layer 7 is not particularly limited, and may be, for example, a metal, a conductive polymer, or the like. These materials may be used alone, or two or more thereof may be used. Examples of the metal include silver, gold, copper, platinum, aluminum, and an alloy containing at least two thereof. Examples of the conductive polymer include a PEDOT (polyethylene dioxythiophene), a PPy (polypyrrole), and a PANI (polyaniline), and these polymers may be appropriately doped with a dopant such as an organic sulfonic acid-based compound, for example, a polyvinyl sulfonic acid, a polystyrene sulfonic acid, a polyallyl sulfonic acid, a polyacrylic sulfonic acid, a polymethacrylic sulfonic acid, a poly-2-acrylamide-2-methylpropane sulfonic acid, or a polyisoprene sulfonic acid. The conductor layer 7 may be a laminate of multiple layers that differ in conductive material.

The film formation method for the conductor layer 7 is not particularly limited, and ALD, sputtering, CVD, coating, plating, or the like can be used.

As described above, the capacitor 20 according to the present embodiment can be manufactured, but is not limited thereto.

The capacitor 20 according to the present embodiment has a conductor-dielectric-conductor structure of the plurality of fibrous core materials 3, the dielectric layer 5, and the conductor layer 7. The plurality of fibrous core materials 3 and the conductor layer 7 out of direct contact with each other, face each other with the dielectric layer 5 interposed therebetween. In the capacitor 20 according to the present embodiment, the plurality of fibrous core materials 3 and the conductor layer 7 are each electrically connected to the outside in any appropriate aspect.

For example, preferably, the fixing layer 4 has conductivity, and the whole substrate 2 is made of a metal. Thus, through the fixing layer 4 from the plurality of fibrous core materials 3, contact can be easily made from the substrate 2 (for example, the back surface 2b). The whole substrate 2 is made of a metal, thereby allowing the resistance value of the capacitor 20 to be reduced, and furthermore, providing high heat resistance.

In addition, for example, the fixing layer 4 may have conductivity, and the surface 2a of the substrate 2 may be provided with a metal layer. Thus, through the fixing layer 4 from the plurality of fibrous core materials 3, contact can be made from the metal layer on the surface 2a of the substrate 2. The metal layer may be a wiring and/or an electrode formed by patterning. Optionally, the back surface 2b of the substrate 2 may be further provided with a metal layer, and the metal layer on the surface 2a and the metal layer on the back surface 2b may be electrically connected, for example, through a via or the like.

The present invention is, however, not limited to these examples, and in the case of the plurality of fibrous core materials 3 in contact with the surface 2a of the substrate 2, the fixing layer 4 is not necessarily conductive. In this case, the material constituting the fixing layer 4 may be, for example, an acrylic non-conductive adhesive or an epoxy non-conductive adhesive.

In contrast, the conductor layer 7 is capable of, from the exposed surface thereof, making contact. For example, the conductor layer 7 can be connected to an external electrode via a wiring, if necessary.

In addition, for example, an additional conductive layer (not illustrated) may be disposed in contact with the tops of the conductor layer 7 corresponding to the other ends E_{b} of the plurality of fibrous core materials 3 to make contact from the additional conductive layer (in this case, gaps may remain). Such an additional conductive layer may be formed, for example, from a conductive paste. The conductive paste is not particularly limited, and known conductive pastes can be used, and may be, for example, a carbon paste, a silver paste, and the like. If necessary, such an additional conductive layer may be covered with a resin layer (not illustrated) on the side opposite to the conductor layer 7. The resin layer may serve as an exterior resin that seals the element structure (conductor-dielectric-conductor structure) of the capacitor 20. The resin layer may be formed from any suitable resin material. The resin material is not particularly limited, and known sealing resin materials can be used, which may be, for example, fine particles such as silica dispersed in a thermosetting epoxy resin.

The capacitor 20 according to the present invention can be subjected to various modifications. For example, as in a capacitor 20′ illustrated in FIG. 3, a conductor layer 7′ may extend so as to fill the surface irregularity of the dielectric layer 5 on the side opposite to the plurality of fibrous core materials 3. In this case, contact can be more easily made from the conductor layer 7′.

### Embodiment 2

The present embodiment relates to an aspect in which a plurality of fibrous core materials are indirectly covered with a dielectric layer. In the present embodiment, the description in Embodiment 1 can also apply to the present embodiment, unless otherwise specified.

Referring to FIG. 4, in a capacitor 30 according to the present embodiment, a plurality of fibrous core materials 3 are each, with at least one end E_{b} thereof exposed (in other words, for the part excluding the at least one end Eₐ thereof), covered with a dielectric layer 5 indirectly (with another conductor layer 9 interposed therebetween) according to the present embodiment. Further, the dielectric layer 5 is covered with a conductor layer (first conductor layer) 7.

More particularly, in the capacitor 30 according to the present embodiment, the surface of a fixing layer 4 on the side opposite to the substrate 2 and the surfaces of parts of the plurality of fibrous core materials 3, not embedded in the fixing layer 4, are covered with another conductor layer (second conductor layer) 9, and the other conductor layer (second conductor layer) 9 is sequentially covered with the dielectric layer 5 and the conductor layer (first conductor layer) 7.

According to the present embodiment, a conductor-dielectric-conductor structure is formed by the second conductor layer 9, the dielectric layer 5, and the first conductor layer 7. Such a conductor-dielectric-conductor structure can be understood as corresponding to a so-called MIM structure (metal-insulator-metal structure). The capacitor 30 that has such a structure can obtain large capacitance from the large specific surface area of the plurality of fibrous core materials 3, because the second conductor layer 9 present thereon also has a large specific surface area. The plurality of fibrous core materials 3 may have conductivity, or have no conductivity. If the plurality of fibrous core materials 3 have conductivity, the resistance value of the capacitor 30 can be, when the conductivity is low, reduced by providing the second conductor layer 9, as compared with a case without the second conductor layer 9. When the plurality of fibrous core materials 3 have no conductivity, the plurality of fibrous core materials 3 function as a base for the second conductor layer 9.

Referring to FIG. 4 again, the plurality of fibrous core materials 3 are each, for the excluding a fixing layer embedded part 3a, covered with the second conductor layer 9, the second conductor layer 9 is covered with the dielectric layer 5, and further, the dielectric layer 5 is covered with the first conductor layer 7.

From another point of view, for each of the plurality of fibrous core materials 3, the boundary between the part covered with the dielectric layer 5 and the part exposed from the dielectric layer 5 is not present inside the fixing layer 4, but is thus located outside the fixing layer 4. In the present embodiment, for each of the plurality of fibrous core materials 3, the boundary between the part covered with the dielectric layer 5 and the part exposed from the dielectric layer 5 is located outside the outer surface of the fixing layer 4.

The thickness of the second conductor layer 9 may be, for example, 3 nm or more, preferably 10 nm or more. The thickness of the second conductor layer 9 is 3 nm or more, thereby allowing the resistance value of the second conductor layer 9 itself to be reduced. In addition, the thickness of the second conductor layer 9 may be, for example, 500 nm or less, particularly 100 nm or less.

The conductive material constituting the second conductor layer 9 is not particularly limited, but may be selected from those described above for the first conductor layer 7 in Embodiment 1. The conductive material constituting the second conductor layer 9 may be the same as or different from the conductive material constituting the first conductor layer 7.

The capacitor 30 according to the present embodiment may be manufactured by forming the second conductor layer 9 after embedding and then fixing, in the fixing layer 4, the one end Eₐ for each of the plurality of fibrous core materials 3 and before forming the dielectric layer 5 in the method for manufacturing the capacitor 20 described above in Embodiment 1. The method for forming the second conductor layer 9 is not particularly limited, and ALD, sputtering, CVD, coating, plating, or the like can be used.

The capacitor 30 according to the present embodiment has a conductor-dielectric-conductor structure of the second conductor layer 9, the dielectric layer 5, and the first conductor layer 7. The second conductor layer 9 and the first conductor layer 7 out of direct contact with each other, face each other with the dielectric layer 5 interposed therebetween. In the capacitor 30 according to the present embodiment, the second conductor layer 9 and the first conductor layer 7 are each electrically connected to the outside in any appropriate aspect.

For example, preferably, the fixing layer 4 has conductivity, and the whole substrate 2 is made of a metal. Thus, through the fixing layer 4 from the second conductor layer 9, contact can be easily made from the substrate 2 (for example, a back surface 2b). The whole substrate 2 is made of a metal, thereby allowing the resistance value of the capacitor 20 to be reduced, and furthermore, providing high heat resistance.

In addition, for example, the fixing layer 4 may have conductivity, and the surface 2a of the substrate 2 may be provided with a metal layer. Thus, through the fixing layer 4 from the second conductor layer 9, contact can be made from the metal layer on the surface 2a of the substrate 2. The metal layer may be a wiring and/or an electrode formed by patterning. Optionally, the back surface 2b of the substrate 2 may be further provided with a metal layer, and the metal layer on the surface 2a and the metal layer on the back surface 2b may be electrically connected, for example, through a via or the like.

The present invention is, however, not limited to these examples, and contact may be made directly from the second conductor layer 9. The second conductor layer 9 can be connected to an external electrode via a wiring, if necessary. In this case, the fixing layer 4 and the substrate 2 are not necessarily conductive.

In contrast, in the same manner as described above in Embodiment 1, contact may be made from the exposed surface of the first conductor layer 7, or contact may be made via an additional conductive layer.

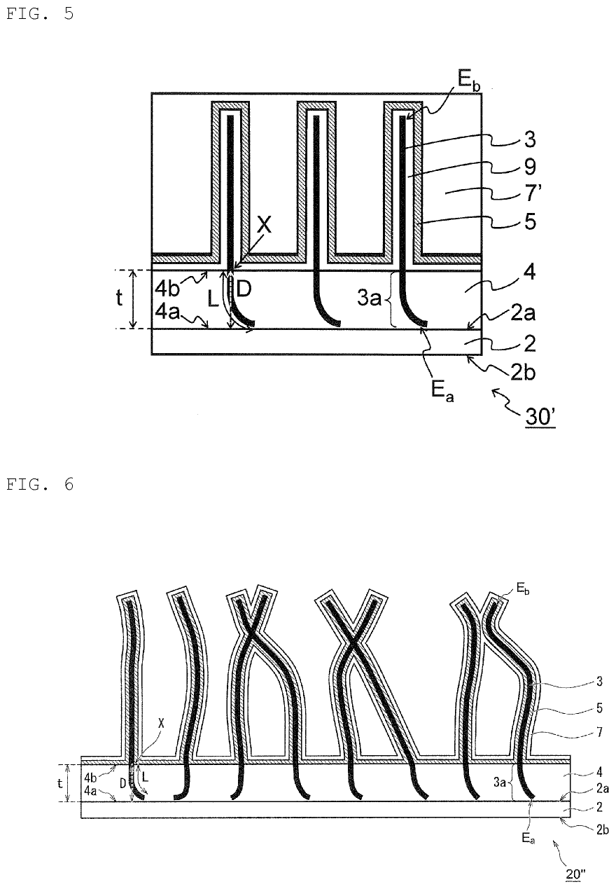

The capacitor 30 according to the present invention can be subjected to various modifications. For example, as in a capacitor 30′ illustrated in FIG. 5, a first conductor layer 7′ may extend so as to fill the surface irregularity of the dielectric layer 5 on the side opposite to the plurality of fibrous core materials 3 (and the second conductor layer 9).

### Embodiment 3

The present embodiment relates to an aspect in which a plurality of fibrous core materials are not necessarily vertically aligned with respect to a substrate. In the present embodiment, the description in Embodiment 1 or 2 can also apply to the present embodiment, unless otherwise specified.

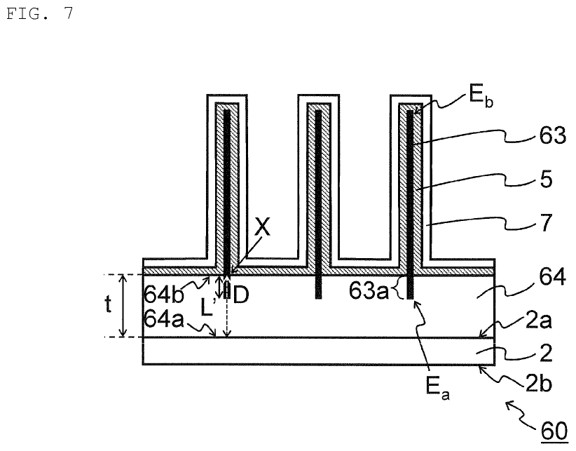

Referring to FIG. 6, in a capacitor 20″ according to the present embodiment, a plurality of fibrous core materials 3 include a fibrous core that is not vertically aligned with respect to a substrate 2. In other words, a fixing layer 4 may have one end Eₐ embedded for each of the plurality of fibrous core materials 3, while fixing the plurality of fibrous core materials 3 to the substrate 2 in an arbitrary condition. For example, among the plurality of fibrous core materials 3, the parts exposed from the substrate 2 (the parts excluding the fixing layer embedded parts 3a) of at least some fibrous core materials 3 may be non-straight, and may be, for example, curved, bent, and/or inclined. In addition, for example, among the plurality of fibrous core materials 3, the parts exposed from the substrate 2 (the parts excluding the fixing layer embedded parts 3a) of any two or more fibrous core materials 3 may have contact with (or intersect with) each other. The height of the other end E_{b} for each of the plurality of fibrous core materials 3 (for example, the height from the surface of the substrate 2) may be substantially uniform, or may be non-uniform (may be uniform).

Also in the present embodiment, the plurality of fibrous core materials 3 are each, with at least the one end E_{b} exposed (in other words, excluding the at least the one end Eₐ), covered with a dielectric layer 5, and the dielectric layer 5 is covered with a conductor layer (first conductor layer) 7. For example, as described above, when among the plurality of fibrous core materials 3, the parts exposed from the substrate 2 (the parts excluding the fixing layer embedded parts 3a) of any two or more fibrous core materials 3 may have contact with (or intersect with) each other, the dielectric layer 5 and the conductor layer 7 are formed around the contact point of the two or more fibrous core materials 3 at the contact point and in the vicinity thereof.

Also in the present embodiment, a conductor-dielectric-conductor structure (corresponding to a so-called MIM structure) is formed by the plurality of fibrous core materials 3, the dielectric layers 5, and the conductor layers 7, and the capacitor 20″ according to the present embodiment can operate as a capacitor.

Although the features of the present embodiment have been exemplarily described with reference to FIG. 6 as a case of modifying Embodiment 1 described above with reference to FIGS. 1 and 2, the features of the present embodiment may be combined with the modification example of Embodiment 1 described above with reference to FIG. 3, Embodiment 2 described above with reference to FIG. 4, and the modification example of Embodiment 2 described above with reference to FIG. 5.

The capacitor according to the present invention may be utilized for any suitable application, and may also be suitably utilized, for example, when thermal stress or mechanical stress may be applied in the process of manufacturing the capacitor and/or during the use thereof by a user. The capacitor according to the present invention has a large effective specific surface area per volume, and can be suitably utilized when the reduction in size (more particularly, the reduction in height) is required.

### DESCRIPTION OF REFERENCE SYMBOLS

2: Substrate
2a: Surface
2b: Back surface
3: Fibrous core material
3a: Fixing layer embedded part
4: Fixing layer
4a, 4b: Main surface
5: Dielectric layer
7, 7′: Conductor layer (first conductor layer)
9: Another conductor layer (second conductor layer)
20, 20′, 20″, 30, 30′: Capacitor
Eₐ, E_{b}: End
L: Length
D: Distance
X: Contact
t: Thickness

1. A capacitor comprising:
a substrate;
a fixing layer with a first main surface and a second main surface that face each other, the fixing layer disposed to have the first main surface in contact with a surface of the substrate;
a plurality of fibrous core materials each having a first end and a second end, the first end of each of the plurality of fibrous core materials being embedded in the fixing layer, and the second end of each of the plurality of fibrous core materials being exposed from the fixing layer;
a dielectric layer covering the second end of each of the plurality of fibrous core materials that are exposed from the fixing layer; and
a conductor layer covering the dielectric layer, wherein
a length of a part of each of the plurality of fibrous core materials embedded in the fixing layer is larger than a distance between a contact between the plurality of fibrous core materials and the second main surface of the fixing layer and the first main surface of the fixing layer.

2. The capacitor according to claim 1, wherein for each of the plurality of fibrous core materials, a boundary between a part thereof covered with the dielectric layer and a part exposed from the dielectric layer is located outside the fixing layer.

3. The capacitor according to claim 1, wherein the plurality of fibrous core materials are each a nanotube or a nanorod.

4. The capacitor according to claim 1, wherein the fibrous core materials are each a carbon nanotube.

5. The capacitor according to claim 1, wherein at least the surface of the substrate is made of a metal.

6. The capacitor according to claim 1, wherein the conductor layer fills a surface irregularity of the dielectric layer on a side thereof opposite to the plurality of fibrous core materials.

7. The capacitor according to claim 1, wherein the plurality of fibrous core materials and the fixing layer have conductivity.

8. The capacitor according to claim 1, wherein the conductor layer is a first conductor layer, and the capacitor further comprises a second conductor layer between the plurality of fibrous core materials and the dielectric layer.

9. The capacitor according to claim 8, wherein the first conductor layer fills a surface irregularity of the dielectric layer on a side thereof opposite to the plurality of fibrous core materials.

10. The capacitor according to claim 1, wherein the surface of the substrate has irregularities.

11. The capacitor according to claim 1, wherein a part of each of the plurality of fibrous core materials exposed from the fixing layer are oriented such that a longitudinal direction thereof is perpendicular to the substrate.

12. The capacitor according to claim 1, wherein at least a part of each of the plurality of fibrous core materials exposed from the fixing layer are not oriented perpendicularly to the substrate.
